(19) United States
(12) Patent Application Publication
(10) Pub. No.: US 2021/0080784 A1
(43) Pub. Date: Mar. 18, 2021

(54) DISPLAY DEVICE

(71) Applicant: Japan Display Inc., Tokyo (JP)

(72) Inventor: Takaharu MATSUOKA, Tokyo (JP)

(21) Appl. No.: 17/017,189

(22) Filed: Sep. 10, 2020

(30) Foreign Application Priority Data
Sep. 13, 2019 (JP) 2019-167438

(51) Int. Cl. G02F 1/13357; F21V 8/00

(52) U.S. Cl. CPC G02F 1/133602; G02B 6/0088

(57) ABSTRACT

According to an aspect, a display device includes: a display panel; a backlight disposed on a back side of the display panel and including a light guiding plate and a plurality of optical sheets, the optical sheets and the light guiding plate being superposed; and a housing body including a first and a second housing body and housing therein the backlight. When viewed in a plane, the backlight includes a first side peripheral part and a second side peripheral part. The first side peripheral part is provided with a strip, which is a projecting part of each of the optical sheets that is bent along a lateral face of the light guiding plate. The first housing body includes a planar part overlapping the backlight and a first vertical wall part projecting from the planar part toward a front side and covering the second side peripheral part.

### CROSS-REFERENCE TO RELATED APPLICATIONS

This application claims priority from Japanese Application No. 2019-167438, filed on Sep. 13, 2019, the contents of which are incorporated by reference herein in its entirety.

### BACKGROUND

### 1. Technical Field

The present disclosure relates to a display device.

### 2. Description of the Related Art

Transmissive display devices have been available in which a backlight device is disposed on a back side of a display panel and light from the backlight device is used to display an image on the display panel (Japanese Patent Application Laid-open Publication No. 2015-210852, for example).

In the display devices, it is desired to attain a narrowed frame, that is, narrowing a frame region located around the outer periphery of a display region.

For the foregoing reasons, there is a need for a display device capable of attaining a narrowed frame.

### SUMMARY

According to an aspect, a display device includes: a display panel; a backlight disposed on a back side of the display panel and including a light guiding plate and a plurality of optical sheets, the optical sheets and the light guiding plate being superposed; and a housing body including a first housing body disposed on a back side of the backlight and a second housing body disposed on a front side of the backlight, the housing body housing therein the backlight. When viewed in a plane, the backlight includes a first side peripheral part on a first side of a central part positioned at a center and a second side peripheral part on a second side of the central part opposite to the first side. The first side peripheral part of the backlight is provided with a strip, the strip being a projecting part of each of the optical sheets that is bent along a lateral face of the light guiding plate. The first housing body includes a planar part and a first vertical wall part, the planar part overlapping the backlight, the first vertical wall part projecting from the planar part toward a front side and covering the second side peripheral part of the backlight.

### BRIEF DESCRIPTION OF THE DRAWINGS

FIG. 1 is a sectional view of a display device according to an embodiment, which illustrates section I-I of FIG. 3;

FIG. 2 is a sectional view of the display device according to the embodiment, which illustrates section II-II of FIG. 3;

FIG. 3 is an exploded perspective view of a backlight, light sources, and a housing body;

FIG. 4 is a plan view of a polarizing sheet when viewed from above;

FIG. 5 is a side view of FIG. 4 when viewed in an A direction;

FIG. 6 is a plan view of a first condensing sheet when viewed from above;

FIG. 7 is a side view of FIG. 6 when viewed in a B direction;

FIG. 8 is a plan view of a second condensing sheet when viewed from above;

FIG. 9 is a side view of FIG. 8 when viewed in a C direction;

FIG. 10 is a plan view of a diffusing sheet when viewed from above;

FIG. 11 is a side view of FIG. 10 when viewed in a D direction; and

FIG. 12 is a plan view of a first housing body when viewed from above.

### DETAILED DESCRIPTION

An embodiment of the present disclosure will be described in detail with reference to the drawings. The description of the following embodiment does not intend to limit the present disclosure. Components described below include those a person skilled in the art could easily conceive of and those that are substantially the same. Furthermore, the components described below can be combined as appropriate.

The disclosure is merely an example, and, as may be understood, the scope of the present disclosure includes any change that a person skilled in the art could easily conceive of and that could be made as appropriate while the spirit of the disclosure is maintained. Although the width, the thickness, the shape, and the like of constituents may be schematically represented in the drawings as compared with the actual mode in order to clarify the description, it is merely an example and does not intend to limit the interpretation of the present disclosure. In the present specification and the drawings, the same reference signs are given to the same components as those described earlier for the drawings that have been previously presented, and detailed descriptions thereof are sometimes omitted. Furthermore, X, Y, and Z directions are illustrated in the drawings by way of example, and these directions do not limit the present disclosure.

In this disclosure, when an element is described as being “on” another element, the element can be directly on the other element, or there can be one or more elements between the element and the other element.

### Embodiment

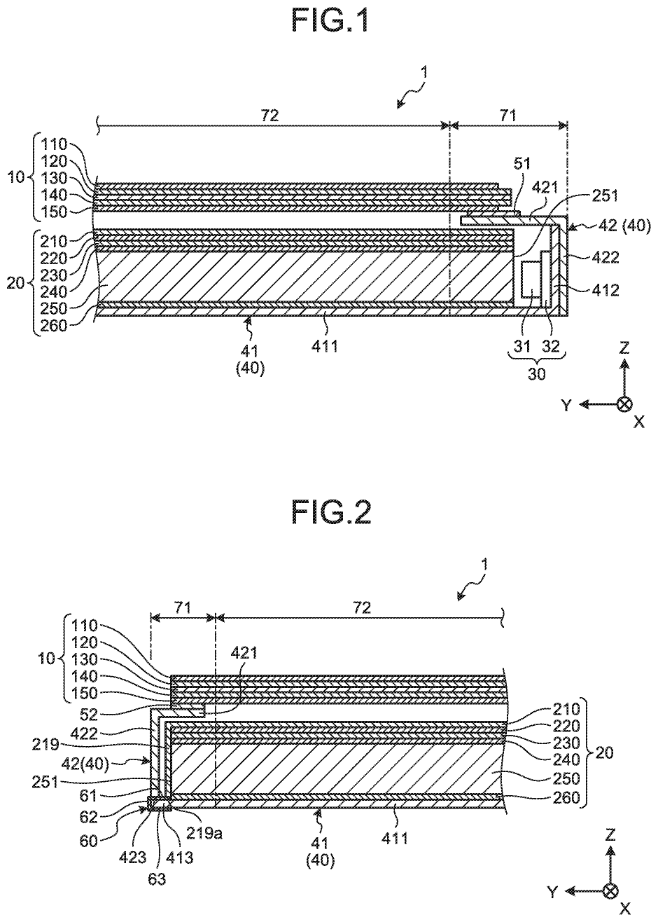

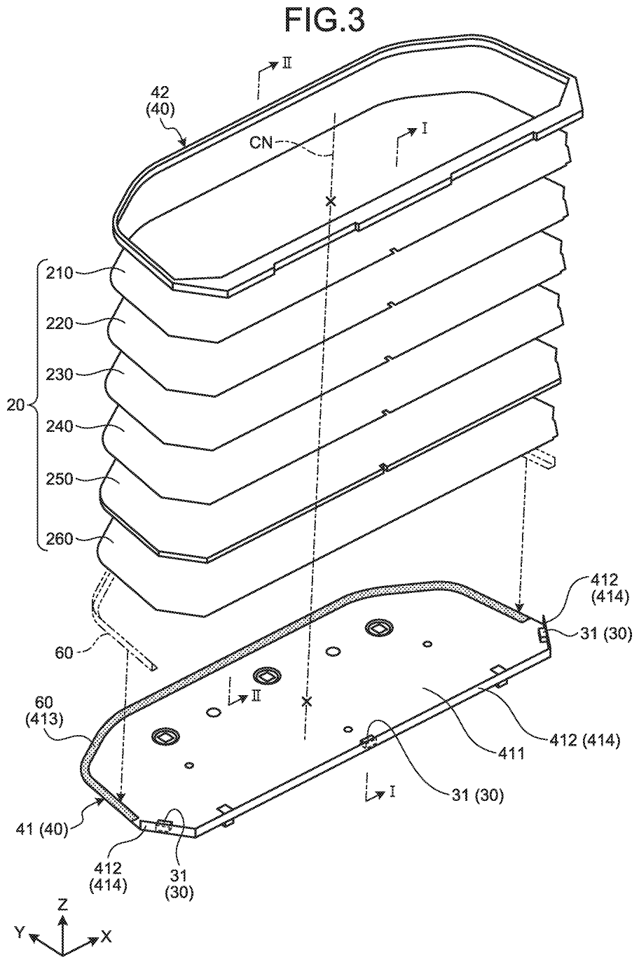

FIG. 1 is a sectional view of a display device according to an embodiment, which illustrates section I-I of FIG. 3. FIG. 2 is a sectional view of the display device according to the embodiment, which illustrates section II-II of FIG. 3. FIG. 3 is an exploded perspective view of a backlight, light sources, and a housing body.

As illustrated in FIG. 1 to FIG. 3, a display device 1 of the present embodiment includes a display panel 10, a backlight (an illuminator) 20, light sources 30, and a housing body 40. The display device 1, for example, causes the display panel 10 to modulate light emitted from the backlight 20, thereby displaying an image on a display surface.

The display panel 10 includes a first polarizing plate 110, a first substrate 120, a liquid crystal layer 130, a second substrate 140, and a second polarizing plate 150. The first polarizing plate 110 is disposed on the forefront side (the upper side, the +Z side, in FIGS. 1 and 2), and the first substrate 120 is disposed on the back side (the underside, the −Z side, in FIGS. 1 and 2) of the first polarizing plate 110. The liquid crystal layer 130 is disposed on the back side of the first substrate 120, and the second substrate 140 is disposed on the back side of the liquid crystal layer 130. The second polarizing plate 150 is disposed on the back side of the second substrate 140.

Light emitted from the backlight 20 toward the front side (the upper side, the +Z side, in FIGS. 1 and 2) passes through the second polarizing plate 150 and the second substrate 140, enters the liquid crystal layer 130, and is modulated by the liquid crystal layer 130. The light modulated by the liquid crystal layer 130 passes through the first substrate 120 and the first polarizing plate 110, and is recognized as an image. The second polarizing plate 150 converts the light emitted from the backlight 20 into linear polarization. The first polarizing plate 110 transmits or intercepts the light depending on the state of the orientation (modulation amount) of the liquid crystal layer 130.

The display panel 10 has a light transmitting part 72 and a light shielding part 71 that is disposed on the outer peripheral side of the light transmitting part 72. The light transmitting part 72 is a display region of the display device 1, and the light shielding part 71 is a frame region of the display device 1.

The backlight 20 is disposed on the back side (the underside, the −Z side, in FIGS. 1 and 2) of the display panel 10. The backlight 20 includes a polarizing sheet 210, a first prism sheet 220, a second prism sheet 230, a diffusing sheet 240, a light guiding plate 250, and a reflecting sheet 260, for example. The polarizing sheet 210, the first prism sheet 220, the second prism sheet 230, and the diffusing sheet 240 are referred to as optical sheets.

The first prism sheet 220 is disposed on the back side (the underside, the −Z side, in FIGS. 1 and 2) of the polarizing sheet 210. The second prism sheet 230 is disposed on the back side of the first prism sheet 220. The diffusing sheet 240 is disposed on the back side of the second prism sheet 230. The light guiding plate 250 is disposed on the back side of the diffusing sheet 240. The reflecting sheet 260 is disposed on the back side of the light guiding plate 250. Consequently, the backlight 20 includes the light guiding plate 250 and a plurality of optical sheets that are superposed on the light guiding plate 250.

As illustrated in FIG. 1, the light source 30 includes a light emitter 31 and a mounting board 32, for example. The light emitter 31 is, for example, a light emitting diode (LED). The light emitter 31 is mounted on the mounting board 32. The light emitter 31 is disposed on the lateral side of the light guiding plate 250. Specifically, the light emitter 31 is provided so as to face a lateral face 251 of the light guiding plate 250.

The polarizing sheet 210 illustrated in FIG. 1 to FIG. 3 is an optical sheet that transmits, of incident light, only light polarized in a predetermined direction. For the polarizing sheet 210, materials that are well known in the field of luminaires can be used. Specifically, a polycarbonate resin can be used for the polarizing sheet 210, for example.

The first prism sheet 220 and the second prism sheet 230 control directivity of light that has entered from the back side, thereby improving the brightness of light exiting to the front side. The first prism sheet 220 and the second prism sheet 230 serve as condensing sheets. For the first prism sheet 220 and the second prism sheet 230, a polycarbonate resin can be used, for example.

The diffusing sheet 240 internally diffuses light that has entered from the light guiding plate 250 on the back side thereof, thereby rendering the brightness of light exiting from the front side uniform.

The light guiding plate 250 internally diffuses light that has entered from the light emitter 31, and emits the diffused light from an outgoing face on the front side thereof. For the light guiding plate 250, materials that are well known in the field of luminaires can be used. Specifically, a transmissive resin, such as an acrylic resin and a polycarbonate resin, is used for the light guiding plate 250.

The reflecting sheet 260 reflects light that has leaked from the back side of the light guiding plate 250, thereby causing the light to re-enter the light guiding plate 250. A reflecting sheet 260 may have a function of diffusing light, a function of scattering light, or other functions, in addition to the function of reflecting light. For the reflecting sheet 260, materials that are well known in the field of luminaires can be used. Specifically, an enhanced specular reflector (ESR) sheet can be used for the reflecting sheet 260, for example.

The housing body 40 includes a first housing body 41 and a second housing body 42. The first housing body 41 is also referred to as a lower frame, and the second housing body 42 is also referred to as an upper frame. The first housing body 41 is disposed on the back side of the backlight 20, and the second housing body 42 is disposed on the front side of the backlight 20. The first housing body 41 and the second housing body 42 are assembled vertically, whereby the backlight 20 is housed therebetween. The first housing body 41 and the second housing body 42 are formed of, for example, metal such as an aluminum alloy, in the present embodiment.

As illustrated in FIG. 3, the first housing body 41 has a substantially rectangular shape in a plane view extending in the X direction. The first housing body 41 includes a planar part 411 and a first vertical wall part 412. When the planar part 411 is viewed in a plane, assume that the center thereof in the X direction and the center thereof in the Y direction are a central part CN. Then, the periphery on a first side (the +Y side, for example) of the central part CN is referred to as a first side peripheral part 413, and the periphery on a second side (the −Y side, for example) of the central part CN is referred to as a second side peripheral part 414. In this case, the second side peripheral part 414 of the planar part 411 is provided with the first vertical wall part 412 projecting toward the front side (the upper side, the +Z side, in FIGS. 1 and 3). The first side peripheral part 413 (the peripheral part) of the planar part 411 has a light shielding tape 60 stuck thereon. The light shielding tape 60 extends along the first side peripheral part 413, as indicated by hatching in FIG. 3. To the light shielding tape 60, black plastic tape is applicable, for example. The second housing body 42 includes a second vertical wall part 422 extending in the Z direction and a horizontal part 421 extending in the Y direction, as illustrated in FIGS. 1 and 2. The horizontal part 421 extends in the Y direction from the end on the +Z side of the second vertical wall part 422. The second vertical wall part 422 and the horizontal part 421 are integrated to be L-shaped as a whole. The horizontal part 421 has adhesive tape 51, 52 stuck on the front side thereof. Through the adhesive tape 51, 52, the display panel 10 is fixed to the horizontal part 421. Furthermore, the second vertical wall part 422 is positioned on the −Y side (the outside) of the first vertical wall part 412 of the first housing body 41, as illustrated in FIG. 1. The structures of the first housing body 41 and the second housing body 42 will be described later in further detail.

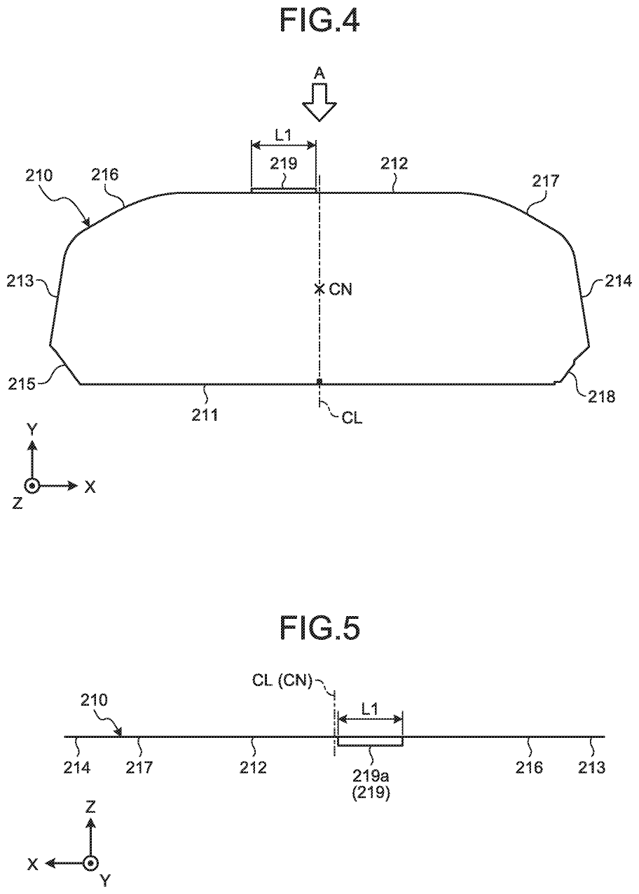

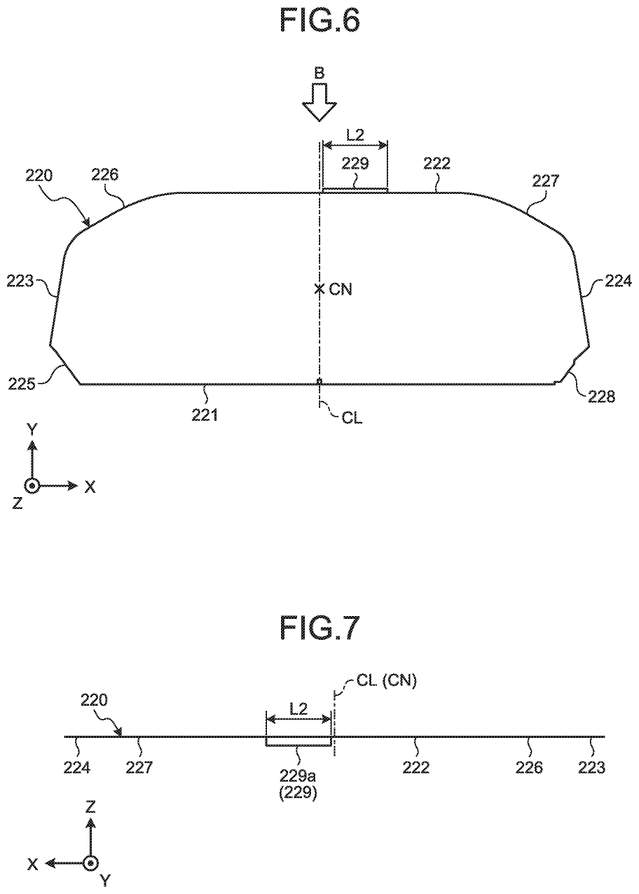

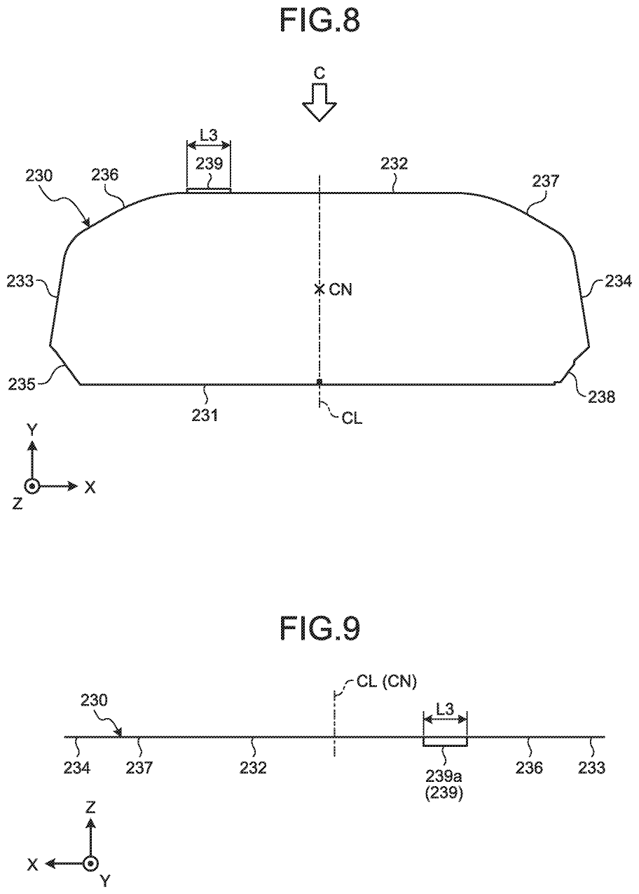

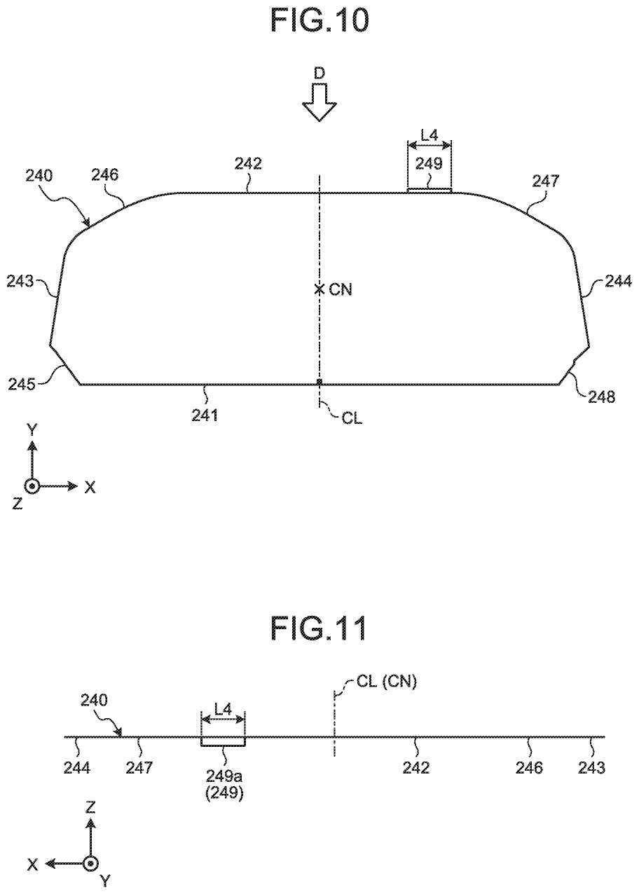

FIG. 4 is a plan view of the polarizing sheet when viewed from above. FIG. 5 is a side view of FIG. 4 when viewed in an A direction. FIG. 6 is a plan view of the first condensing sheet when viewed from above. FIG. 7 is a side view of FIG. 6 when viewed in a B direction. FIG. 8 is a plan view of the second condensing sheet when viewed from above. FIG. 9 is a side view of FIG. 8 when viewed in a C direction. FIG. 10 is a plan view of the diffusing sheet when viewed from above. FIG. 11 is a side view of FIG. 10 when viewed in a D direction.

As illustrated in FIGS. 4, 6, 8, and 10, the polarizing sheet 210, the first prism sheet 220, the second prism sheet 230, and the diffusing sheet 240 are substantially the same in shape in a plane view. As illustrated in FIG. 4, the periphery of the polarizing sheet 210 has a first side 211, a second side 212, a third side 213, a fourth side 214, a fifth side 215, a sixth side 216, a seventh side 217, and an eighth side 218. The first side 211 is the edge on the −Y side and extends in the X direction. The second side 212 is the edge on the +Y side and extends in the X direction. The third side 213 is the edge on the −X side and extends in the Y direction. The fourth side 214 is the edge on the +X side and extends in the Y direction. The fifth side 215 is positioned at the corner where the first side 211 and the third side 213 intersect. The fifth side 215 extends in the −X direction and the +Y direction. The sixth side 216 is positioned at the corner where the second side 212 and the third side 213 intersect. The sixth side 216 extends in the +X direction and the +Y direction. The seventh side 217 is positioned at the corner where the second side 212 and the fourth side 214 intersect. The seventh side 217 extends in the +X direction and the −Y direction. The eighth side 218 is positioned at the corner where the first side 211 and the fourth side 214 intersect. The eighth side 218 extends in the +X direction and the +Y direction.

The periphery of the polarizing sheet 210 has a first side peripheral part and a second side peripheral part, in a manner similar to the first housing body 41 described earlier. In other words, as illustrated in FIG. 4, when the polarizing sheet 210 is viewed in a plane, assume that the center thereof in the X direction and the center thereof in the Y direction are the central part CN. Then, the periphery on a first side (the +Y side) of the central part CN is referred to as the first side peripheral part, and the periphery on a second side (the −Y side) of the central part CN is referred to as the second side peripheral part. In this case, the second side 212 serving as the first side peripheral part is provided with a strip 219, as illustrated in FIGS. 4 and 5. In the polarizing sheet 210, assume that a straight line passing through the center thereof in the X direction and extending in the Y direction is a central line CL. Then, the strip 219 is disposed on the −X side of the central line CL. A lower end 219a of the strip 219 is in contact with a first part 61 of the light shielding tape 60 illustrated in FIG. 2, as will be described later. The strip 219 has a length of L1 in the X direction. The strip 219 is integrally attached to the second side 212 so as to be bendable. In this manner, the strip 219 is a projecting part of the polarizing sheet 210 (the optical sheet), and the strip 219 can be bent along the lateral face 251 of the light guiding plate 250. The strip 219 has perforations at the base, which makes it easy for the strip 219 to be bent from the base. Strips 229, 239, 249 also have perforations at their bases.

As illustrated in FIG. 6, the periphery of the first prism sheet 220 has a first side 221, a second side 222, a third side 223, a fourth side 224, a fifth side 225, a sixth side 226, a seventh side 227, and an eighth side 228. The first side 221 corresponds to the first side 211 of the polarizing sheet 210. The second side 222 corresponds to the second side 212 of the polarizing sheet 210. Likewise, the third side 223, the fourth side 224, the fifth side 225, the sixth side 226, the seventh side 227, and the eighth side 228 respectively correspond to the third side 213, the fourth side 214, the fifth side 215, the sixth side 216, the seventh side 217, and the eighth side 218 of the polarizing sheet 210.

As illustrated in FIG. 6, when the first prism sheet 220 is viewed in a plane, assume that the center thereof in the X direction and the center thereof in the Y direction are the central part CN. Then, the periphery on a first side (the +Y side) of the central part CN is referred to as a first side peripheral part, and the periphery on a second side (the −Y side) of the central part CN is referred to as a second side peripheral part. In this case, the second side 222 serving as the first side peripheral part is provided with the strip 229, as illustrated in FIGS. 6 and 7. In the first prism sheet 220, assume that a straight line passing through the center thereof in the X direction and extending in the Y direction is a central line CL. Then, the strip 229 is disposed on the +X side of the central line CL. The strip 229 is integrally attached to the second side 222 so as to be bendable. The strip 229 has a length of L2 in the X direction. A lower end 229a of the strip 229 is in contact with the first part 61 of the light shielding tape 60 illustrated in FIG. 2.

As illustrated in FIG. 8, the periphery of the second prism sheet 230 has a first side 231, a second side 232, a third side 233, a fourth side 234, a fifth side 235, a sixth side 236, a seventh side 237, and an eighth side 238. The first side 231 corresponds to the first side 211 of the polarizing sheet 210. The second side 232 corresponds to the second side 212 of the polarizing sheet 210. Likewise, the third side 233, the fourth side 234, the fifth side 235, the sixth side 236, the seventh side 237, and the eighth side 238 respectively correspond to the third side 213, the fourth side 214, the fifth side 215, the sixth side 216, the seventh side 217, and the eighth side 218 of the polarizing sheet 210.

As illustrated in FIG. 8, when the second prism sheet 230 is viewed in a plane, assume that the center thereof in the X direction and the center thereof in the Y direction are the central part CN. Then, the periphery on a first side (the +Y side) of the central part CN is referred to as a first side peripheral part, and the periphery on a second side (the −Y side) of the central part CN is referred to as a second side peripheral part. In this case, the second side 232 serving as the first side peripheral part is provided with the strip 239, as illustrated in FIGS. 8 and 9. The strip 239 is provided closer to the −X side than the strip 219 illustrated in FIGS. 4 and 5 is. The strip 239 is integrally attached to the second side 232 so as to be bendable. The strip 239 has a length of L3 in the X direction. A lower end 239a of the strip 239 is in contact with the first part 61 of the light shielding tape 60 illustrated in FIG. 2.

As illustrated in FIG. 10, the periphery of the diffusing sheet 240 has a first side 241, a second side 242, a third side 243, a fourth side 244, a fifth side 245, a sixth side 246, a seventh side 247, and an eighth side 248. The first side 241 corresponds to the first side 211 of the polarizing sheet 210. The second side 242 corresponds to the second side 212 of the polarizing sheet 210. Likewise, the third side 243, the fourth side 244, the fifth side 245, the sixth side 246, the seventh side 247, and the eighth side 248 respectively correspond to the third side 213, the fourth side 214, the fifth side 215, the sixth side 216, the seventh side 217, and the eighth side 218 of the polarizing sheet 210.

As illustrated in FIG. 10, when the diffusing sheet 240 is viewed in a plane, assume that the center thereof in the X direction and the center thereof in the Y direction are the central part CN. Then, the periphery on a first side (the +Y side) of the central part CN is referred to as a first side peripheral part, and the periphery on a second side (the −Y side) of the central part CN is referred to as a second side peripheral part. In this case, the second side 242 serving as the first side peripheral part is provided with the strip 249, as illustrated in FIGS. 10 and 11. The strip 249 is provided closer to +X side than the strip 229 illustrated in FIGS. 6 and 7 is. The strip 249 is integrally attached to the second side 242 so as to be bendable. The strip 249 has a length of L4 in the X direction. A lower end 249a of the strip 249 is in contact with the first part 61 of the light shielding tape 60 illustrated in FIG. 2. As described above, when the backlight 20 is viewed in a plane, the strips 219, 229, 239, 249 of the optical sheets are arranged in respective positions shifted from each other in the X direction.

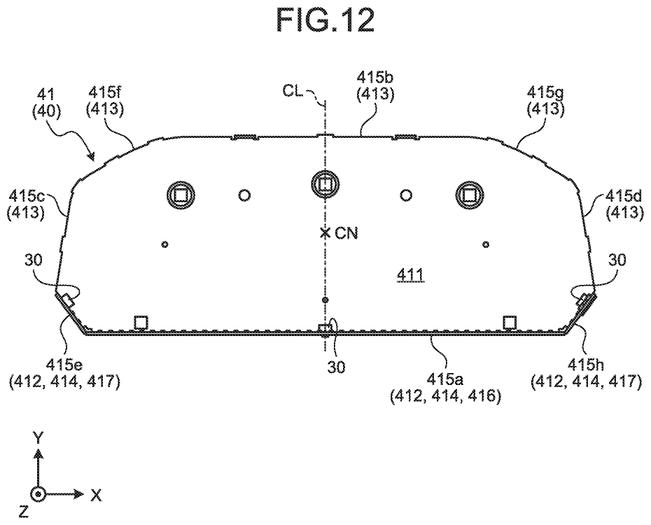

The following describes the structure of the first housing body 41 with reference to FIG. 12. The periphery of the first housing body 41 has a first side 415a, a second side 415b, a third side 415c, a fourth side 415d, a fifth side 415e, a sixth side 415f, a seventh side 415g, and an eighth side 415h. The first side 415a corresponds to the first side 211 of the polarizing sheet 210. The second side 415b corresponds to the second side 212 of the polarizing sheet 210. Likewise, the third side 415c, the fourth side 415d, the fifth side 415e, the sixth side 415f, the seventh side 415g, and the eighth side 415h respectively correspond to the third side 213, the fourth side 214, the fifth side 215, the sixth side 216, the seventh side 217, and the eighth side 218 of the polarizing sheet 210.

As described earlier, when the planar part 411 is viewed in a plane, assume that the center thereof in the X direction and the center thereof in the Y direction are the central part CN. Then, the periphery on the first side (the +Y side) of the central part CN is referred to as the first side peripheral part 413, and the periphery on the second side (the −Y side) of the central part CN is referred to as the second side peripheral part 414. The first side peripheral part 413 includes the second side 415b, the third side 415c, the fourth side 415d, the sixth side 415f, and the seventh side 415g. The second side peripheral part 414 includes the first side 415a, the fifth side 415e, and the eighth side 415h. The second side peripheral part 414 includes a peripheral part body 416 and intersections 417. The peripheral part body 416 is the first side 415a, and the intersections 417 are the fifth side 415e and the eighth side 415h. The fifth side 415e and the eighth side 415h serving as the intersections 417 extend in a direction toward the first side peripheral part 413 and intersect the peripheral part body 416. The first side 415a, the fifth side 415e, and the eighth side 415h serving as the second side peripheral part 414 is provided with the first vertical wall part 412 extending toward the front side (the upper side, the +Z side, in FIGS. 1 and 3). The first vertical wall part 412 covers a second side peripheral part of the backlight 20. The light source 30 is provided on the +Y side (the first side peripheral part 413 side) of each of the first side 415a, the fifth side 415e, and the eighth side 415h in the first vertical wall part 412. Specifically, the light source 30 is disposed on all of a part on the +Y side of the first vertical wall part 412 provided on the first side 415a, a part on the +X side and the +Y side of the first vertical wall part 412 provided on the fifth side 415e, and a part on the −X side and the +Y side of the first vertical wall part 412 provided on the eighth side 415h.

The light shielding tape 60 illustrated in FIG. 3 is stuck on the second side 415b, the third side 415c, the fourth side 415d, the sixth side 415f, and the seventh side 415g so as to run the sides seamlessly. Furthermore, the light shielding tape 60 has a U-shaped section, as illustrated in FIG. 2. Specifically, the light shielding tape 60 has a U-shaped section made up of the first part 61 positioned on the upper side (the +Z side) of the first side peripheral part 413 in the first housing body 41, a second part 62 positioned on lateral side (the +Y side) of the first side peripheral part 413, a third part 63 positioned on the underside (the −Z side) of the first side peripheral part 413. A lower end 423 of the second vertical wall part 422 in the second housing body 42 is positioned at the end on the −Z side the second vertical wall part 422. The lower end 423 is in contact with the first part 61 of the light shielding tape 60. Respective lower ends of the strip 219 of the polarizing sheet 210, the strip 229 of the first prism sheet 220, the strip 239 of the second prism sheet 230, and the strip 249 of the diffusing sheet 240 are in contact with the first part 61 of the light shielding tape 60, which is not illustrated in FIG. 2.

As described above, the display device 1 of the present embodiment includes: the display panel 10; the backlight 20 that is disposed on the back side of the display panel 10, and that includes the light guiding plate 250 and the optical sheets that are superposed on the light guiding plate 250, which are the polarizing sheet 210, the first prism sheet 220, the second prism sheet 230, and the diffusing sheet 240; and the housing body 40 that includes the first housing body 41 disposed on the back side of the backlight 20 and the second housing body 42 disposed on the front side of the backlight 20, and that houses therein the backlight 20. The strips 219, 229, 239, 249 are provided so as to project at the respective first side peripheral parts of the optical sheets, and are bent along the lateral face of the backlight 20 with the optical sheets overlapping each other. The second side peripheral part 414 of the first housing body 41 is provided with the first vertical wall part 412 that projects toward the front side and that covers the second side peripheral part of the backlight 20.

In this manner, the strips 219, 229, 239, 249 are provided so as to project at the respective first side peripheral parts of the optical sheets, and are bent so as to be fixed to the lateral face of the backlight 20. Consequently, the optical sheets can be held without a vertical wall part provided to the first side peripheral part of the first housing body 41, thereby facilitating a narrowed frame, that is, narrowing the light shielding part 71 serving as the frame region of the display device 1. In other words, in order to hold the optical sheets, a vertical wall part previously had to be provided to the first side peripheral part of the first housing body 41 as well. However, no vertical wall part needs to be provided to the first side peripheral part because the strips 219, 229, 239, 249 are provided to the corresponding optical sheets and are fixed to the lateral face of the backlight 20. Consequently, the light shielding part 71 (the frame region) can be narrowed by the thickness of the vertical wall part, thereby facilitating a narrowed frame.

In the present embodiment, when the backlight 20 is viewed in a plane, the strips 219, 229, 239, 249 of the optical sheets are arranged in respective positions shifted from each other. In other words, the strips of given two optical sheets are respectively arranged in positions shifted from each other. Consequently, the holding power to fix the optical sheets to the backlight 20 can be equally dispersed as compared with a case in which the strips are arranged so as to concentrate on a partial place, which in turn can improve the holding power of the optical sheets as a whole.

The first housing body 41 has the light shielding tape 60 stuck along the first side peripheral part 413 (the peripheral part). Consequently, the light shielding tape 60 hinders light from the backlight 20 from exiting outside.

The second side peripheral part 414 of the first housing body 41 includes the peripheral part body 416 and the intersections 417 that extend from the ends of the peripheral part body 416 in a direction toward the backlight 20 and intersect the peripheral part body 416, and the light source 30 is disposed inside each intersection 417. The intersection 417 is a part where light quantity is often insufficient, and thus the light source 30 is disposed at the intersection 417, whereby the light quantity can be increased at the intersection 417.

Although the preferred embodiment of the present disclosure has been described, the embodiment does not intend to limit the present disclosure. The description presented in the embodiment is merely an example, and various changes may be made without departing from the spirit of the present disclosure. As may be understood, any changes made without departing from the spirit of the present disclosure are also included in the technical scope of the present disclosure. At least one of various omissions, substitutions, and changes may be made to the components without departing from the spirit of the embodiments and modifications described above.

What is claimed is:

1. A display device comprising:
a display panel;
a backlight disposed on a back side of the display panel and including a light guiding plate and a plurality of optical sheets, the optical sheets and the light guiding plate being superposed; and
a housing body including a first housing body disposed on a back side of the backlight and a second housing body disposed on a front side of the backlight, the housing body housing therein the backlight, wherein
when viewed in a plane, the backlight includes a first side peripheral part on a first side of a central part positioned at a center and a second side peripheral part on a second side of the central part opposite to the first side,
the first side peripheral part of the backlight is provided with a strip, the strip being a projecting part of each of the optical sheets that is bent along a lateral face of the light guiding plate, and
the first housing body includes a planar part and a first vertical wall part, the planar part overlapping the backlight, the first vertical wall part projecting from the planar part toward a front side and covering the second side peripheral part of the backlight.

2. The display device according to claim 1, wherein, when the backlight is viewed in a plane, the strips of two optical sheets are respectively arranged in positions shifted from each other.

3. The display device according to claim 1, wherein the first housing body has a light shielding tape stuck along a peripheral part.

4. The display device according to claim 2, wherein the first housing body has a light shielding tape stuck along a peripheral part.

5. The display device according to claim 1, wherein
a peripheral part of the first housing body includes a peripheral part body and intersections extending from ends of the peripheral part body in a direction toward the backlight and intersecting the peripheral part body, and
a light source is disposed inside each intersection.

6. The display device according to claim 2, wherein
a peripheral part of the first housing body includes a peripheral part body and intersections extending from ends of the peripheral part body in a direction toward the backlight and intersecting the peripheral part body, and
a light source is disposed inside each intersection.

7. The display device according to claim 3, wherein
a peripheral part of the first housing body includes a peripheral part body and intersections extending from ends of the peripheral part body in a direction toward the backlight and intersecting the peripheral part body, and
a light source is disposed inside each intersection.
